(19) United States
(12) Patent Application Publication
(10) Pub. No.: US 2017/0265379 A1
(43) Pub. Date: Sep. 21, 2017

(54) APPARATUS AND METHODS FOR DISPENSING AGRICULTURAL PRODUCTS

(71) Applicant: 360 Yield Center, LLC, Morton, IL (US)

(72) Inventors: Nowell Moore, Congerville, IL (US); Lee Dahlhauser, Heyworth, IL (US); Rhett Schildroth, North Liberty, IA (US); Lucas Helton, Tremont, IL (US)

(21) Appl. No.: 15/464,327

(22) Filed: Mar. 20, 2017

Related U.S. Application Data
(60) Provisional application No. 62/310,299, filed on Mar. 18, 2016.

(51) Int. Cl. A01C 15/00; A01C 23/04; A01C 21/00

(52) U.S. Cl. CPC A01C 15/007; A01C 21/00; A01C 23/047

(57) ABSTRACT

An apparatus and methods for delivering a particulate product onto a soil surface proximate adjacently spaced crop rows. The apparatus includes a plurality of drop members supported by and spaced laterally along a boom structure such that each drop member is positioned between two adjacently spaced crop rows. The drop member extends downwardly from the boom structure toward the soil surface. The drop member supports a hopper which receives a quantity of particulate product. Diverging particulate product passageways supported from a lower portion of the drop member deliver the particulate product from the hoppers onto the soil surface adjacent the two adjacently spaced crop rows. In alternative embodiments, the drop members may also support liquid passageways for delivering liquid product to the soil surface with the particulate product and the drop members may support spray assemblies for spraying plants in the adjacent crop rows.

### BACKGROUND

In modern farming practices, broadcast or subsurface applications of products, such as fertilizers, to assist plant growth are common practice. For example, applying starter fertilizers at planting within the furrow or subsurface, presents an opportunity to assist plant nutrient needs for a short period of time, and in very limited amounts. Moreover, world goals of an average corn yield of 300 bushels per acre and average soybean yields of 100 bushels per acre have been suggested to help support the ever-growing population's food and energy needs. Agronomic specialists are developing new genetics in grains, creating genetic potential to achieve these higher yield goals. However, conventional fertilizer application systems can only typically be used prior to or at the beginning of the plant's life and do not allow for application of fertilizer when the plant needs it during the plant's life cycle. Moreover, conventional fertilizer application systems are also limited as to where fertilizer can be placed with respect to a plant. These systems typically do not place the fertilizer near the plant in a row; instead placing the fertilizer in the middle of the row far away from the plant. Thus, conventional fertilizer applicators do not allow for the level of fertilization needed for new genetic plant nutrient needs.

### BRIEF DESCRIPTION OF THE DRAWINGS

FIG. 1 is a schematic illustration of an embodiment of a product dispenser shown positioned between adjacent crop rows.

FIG. 2 is another view of the product dispenser in FIG. 1 schematically illustrating an embodiment of a flow control mechanism.

FIG. 3 is a schematic illustration of another embodiment of a product dispenser shown positioned between adjacent crop rows.

FIG. 4 is a top plan view of an embodiment of a drop member with product dispenser having a mini-hopper and shroud.

FIG. 5 is an embodiment of a plurality of drop members supported on a boom with the drop members extending downwardly between adjacent rows, wherein the drop member supports a particulate product dispenser, a liquid product dispenser and a spray assembly.

### DESCRIPTION

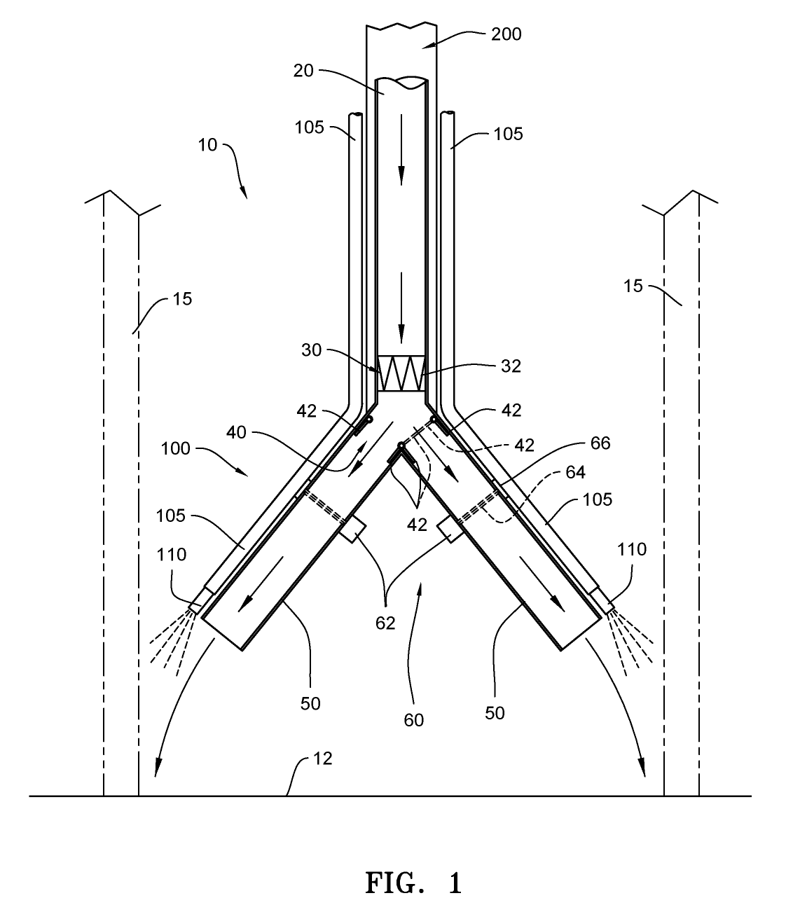

Referring to the drawing figures wherein like reference numerals designate the same or corresponding parts throughout the several view, FIG. 1 is a schematic illustration of a an embodiment of a particulate product dispenser 10 shown positioned above the ground 12 and between adjacent crop rows 15. The product dispenser 10 allows for controlled application of one or more dry fertilizers or other particulate products and liquid or foam products on the ground 12 near the base of the plants of the crop rows 15.

The product dispenser 10 facilitates applying product, within approximately 5 inches of a plant row and at virtually any time during the life of the plants. The product dispenser 10 ensures placement of the product is close enough to the crop rows such that the product can take advantage of runoff moisture created in the evenings in the form of dews. In the early morning hours of the day, the water from dew tends to follow the plant downward to the base of the plant, where it is disbursed into the soil in an area within approximately 5 inches to each side of the plant. This distribution of water assists the soil, through the process of mass flow or diffusion, in moving mineralized plant nutrients to the plant. The dispenser allows the product to enter the soil profile and to be mineralized by soil life, making the product available to the plant during photosynthesis. In the process of photosynthesis, the plant can receive the product along with water from the soil profile, or surface water, if the plant desires to receive the product, into the plant and utilize the product for plant functions.

The dispenser 10 may be used on many types of crops and with many types of products including but not limited to urea, controlled release nitrogen such as ESN®, monoammonium phosphate (MAP), diammonium phosphate (DAP), cover crops, lime, phosphorous, etc. The product dispenser 10 may be configured to apply product before, during or after the crop growing season.

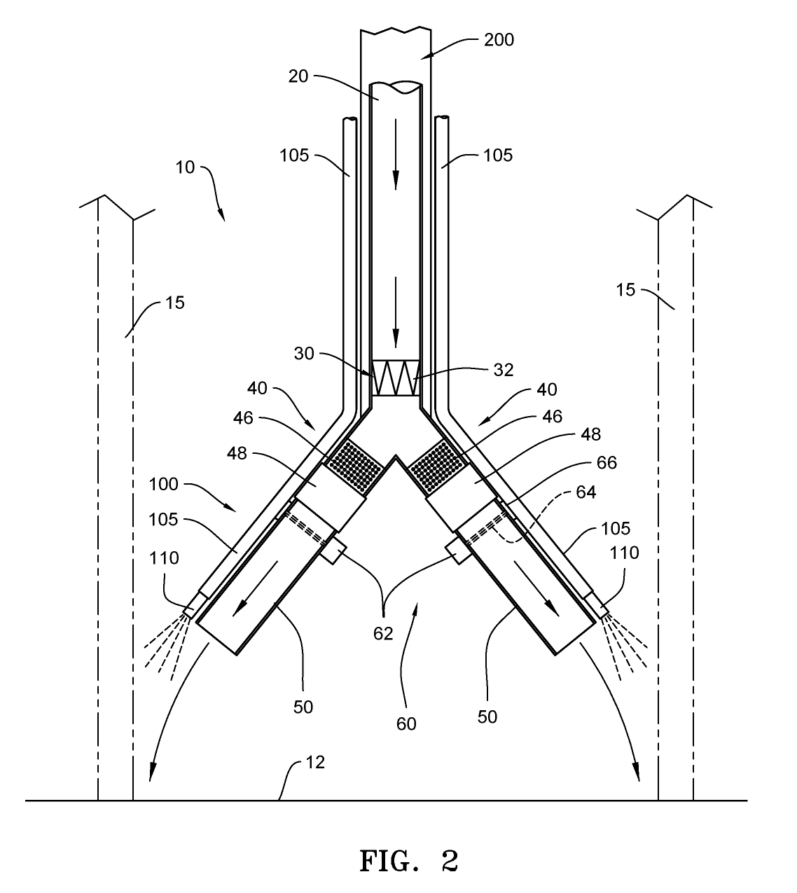

The dispenser 10 may be used with many types of agricultural implements, including self-propelled or pull type sprayers, spreaders, planters, and tillage equipment. It should be appreciated that although FIGS. 1 and 2 illustrate only a single product dispenser 10 disposed between adjacent crop rows 15, typical implements would be configured to address multiple rows and thus could include at least one product dispenser 10 per row.

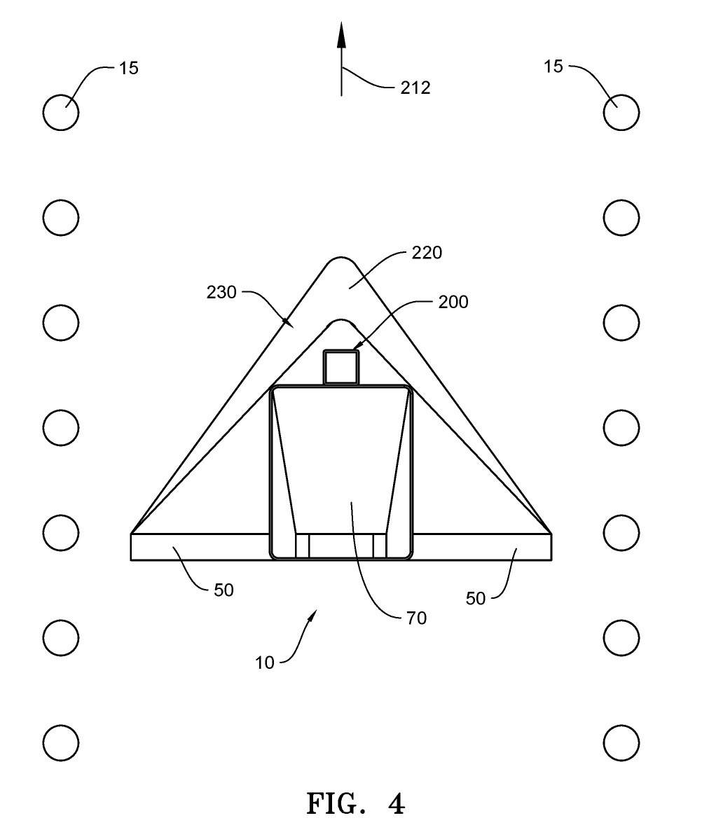

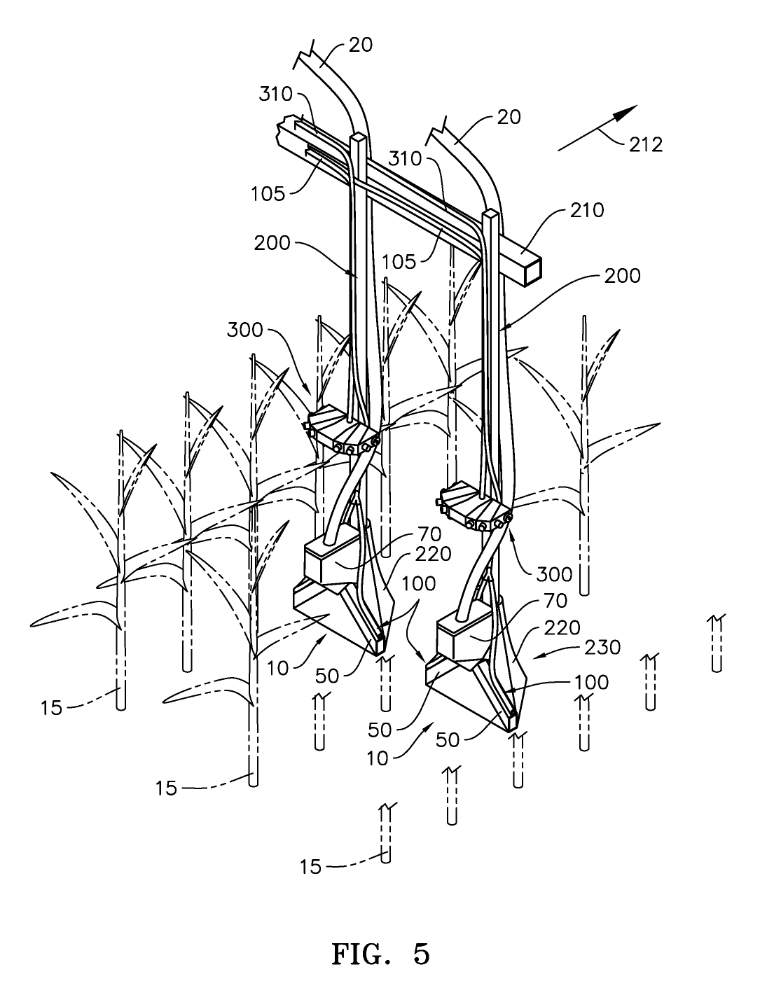

For example, as shown in FIGS. 4 and 5, a plurality of drop members 200 may be mounted on a boom structure 210 of a self-propelled sprayer vehicle (not shown). In such an embodiment, the boom structure 210 extends laterally in a direction transverse to a direction of travel of the sprayer vehicle as indicated by arrow 212 and transverse to the direction of the adjacently spaced crop rows 15. The boom structure 210 is disposed at a height above the soil surface to avoid damage to the crop as it passes. The drop members 200 extend downwardly from the boom structure 210 and are spaced laterally along the boom structure 210 such that each of the plurality of drop assemblies 200 is positioned between two of the adjacently spaced crop rows 15. The product dispensers 10 are mounted to a lower portion of the drop member 200 proximate the soil surface. The drop member 200 may be mounted to the boom structure 210 in any conventional manner which permits lateral adjustment to accommodate different crop row spacings. The drop member 200 may also be mounted so as to be vertically adjustable with respect to the boom structure 210 or, alternatively, the boom structure 210 may be vertically adjustable while the drop member remains vertically fixed relative to the boom structure 210, or both the boom structure and the drop members may be vertically adjustable. Additionally, the drop members 200 may be mounted to the boom structure so as to permit the drop member to swing rearwardly in the event the drop member 200 encounters an obstruction between the crop rows or in the event the drop member is inadvertently lowered to close to the soil surface such that it momentarily drags on the ground due to abrupt elevation changes in the field terrain. Examples of such “break-away” type of mounts for the drop member 200 are disclosed in applicant's U.S. application Ser. No. 15/404,187, which is incorporated herein in its entirety by reference.

As best shown in FIGS. 4-5, the drop member 200 may include a shroud or hood 220 to deflect or divert the crop leaves or other vegetation around the product dispenser 10. In one embodiment, the shroud has a pointed forward or leading end with sidewalls that diverge rearwardly, resulting in triangular shape base unit 230 when viewed in plan (FIG. 4). This configuration provides certain advantages. For example, the triangular or rearwardly diverging configuration allows the base unit 230 to self-align or self-position between crop rows by more easily deflecting off the crop rows if the operator inadvertently veers to one side or the other from the center of the crop rows. Additionally, the triangular or rearwardly diverging shape of the base unit 230 more easily deflects crop leaves or other vegetation which come in contact with the lower portion of the drop member 200 and product dispenser 10, thereby minimizing twisting of the drop member 200 and/or product dispenser 10 while traveling through the field. Additionally, this configuration prevents or minimizes entanglement of neighboring base units as they swing fore and aft and/or side-to-side, which often occurs when the machine or sprayer turns at the end of the crop rows.

As best shown in FIG. 5, the particulate product may be communicated from a bulk hopper or other supply source (not shown) disposed on the sprayer to the product dispenser 10 via blower (not shown) which entrains the particulate product through a conduit, pipe, tube or hose 20.

It is known that some dry products, such as urea, may clump together due to changes in temperature and/or humidity. Thus a declumping tool 30 may be provided to break up these clumps to ensure uniform and consistent particle sizes before it leaves the product dispenser 10. The declumping tool 30 may be provided within the flow of product, either just prior to the dispenser 10 or within the dispenser 10 itself. In FIG. 1, the declumping tool 30 is shown positioned within a supply conduit 20. However it can be appreciate that the declumping tool 30 may be positioned within one of the passageways 50 or other structure through which product passes. As shown in FIG. 1, the declumping tool 30 may be at least one roller 32 rotated by an electric drive (not shown) for example. In another example, the declumping tool 30 is driven by a ground engaging wheel (not shown) attached to the product dispenser 10 or the declumping tool 30 may be pneumatic or hydraulically driven. The declumping tool 30 may also be a device for vibrating a portion of the supply conduit 20 or passageway 30. In such an embodiment the declumping tool 30 may be capable of vibrating the particles and breaking up or preventing clumps of product. The declumping tool 30 may also be adjusted to be more or less aggressive depending on the product being dispensed. The size of the product particle being dispensed is typically important to the efficacy of the product application, i.e., whether or not the plant can use product or how quickly it can use the product.

The passageways 50 of the product dispenser 10 extend laterally outwardly, and in some cases rearwardly, with respect to the direction of travel, towards the crop rows. The passageways 50 may terminate at some predetermined distance above the ground or be configured to drag on the ground as the dispenser moves through a field. The passageways may have a width commensurate to the row width of the particular crop. In one example, the width at the widest point of the passageways 50—which does not necessarily need to be at or near the ends of the passageways—varies from about 9 inches to about 32 inches. In one example, the width between the passageways 50 is designed to allow for 6 inches of total clearance, e.g., 3 inches of clearance on each side of the passageways 50. This clearance between the passageways 50 and the crop row allows the product dispenser 10 to move between crop rows without damaging the crops in those crop rows.

The product dispenser 10 may also utilize an internal flow control mechanism 40 within at least one passageway 50. In one embodiment, the flow control mechanism 40 is a pair of internal gates 42. The gates 42 may be configured to allow for the passageway 50 to be closed, partially closed or open, as well as any positions therebetween, to regulate the flow of product. FIG. 1 shows the gates 42 in a mostly open position. The flow control mechanism 40 may also be a diaphragm valve, such as an IRIS valve, that constricts or expands as called for by a product flow control system to regulate flow of a product.

FIG. 2 shows a product dispenser with another exemplary flow control mechanism 40. In this example, flow control mechanism 40 may be at least one adjustable vent 44 positioned on a sidewall of the passageway 50, supply conduit 20, or other structure through which product passes. The vent 44 may have a screen portion 46 having one or more apertures therein for letting air pass through but keeping product within the passageway 50. The vent 44 further includes a vent cover 48 movable relative to the screen portion 46 to increase or decrease the amount of air being vented through the screen portion 46. By adjusting the vent 44 manually or automatically, i.e., by covering or uncovering a portion of the screen portion 46, the air pressure at that point may be reduced or increased, thereby regulating the flow of product through the passageways 50. For example, a passageway 50 with low pressure (i.e., more of the screen exposed) may have a lower flow rate of product moving through the passageway 50 to the row. Conversely a passageway 50 with higher pressure (i.e., less of the screen exposed) will have a higher flow rate of product moving through the passageway 50 to the row.

As shown in FIG. 1, the product dispenser 10 may use a mass flow sensor 60 positioned near or within each of the passageways 50. In on example, the mass flow sensor 60 is a light emitter 62 outputting one or more beams of light 64 and detecting using a light receiver or detector 66 the amount of light reflected by the product particles passing by. The particles passing through will interrupt the beam of light 64 and generate a signal pulse indicating the presence of a particle. When this information is combined with the product particle size, which can be inputted by a user, the flow rate of product passing through a passageway 50 can be determined. Further, the resulting flow rate calculation may then be used to control the flow control mechanism 40, either as a closed or open loop system. In this manner, the amount of product, e.g., pounds per acre, being applied can be determined. One exemplary light sensor suitable for this application is disclosed in U.S. Pat. No. 7,152,540, incorporated herein by reference.

Finally, it is envisioned that a deflector (not shown) or other suitable structure may be utilized at the end of passageway 50 to redirect and guide the product towards the row. For example, in applications where the product is entrained in air, blown to dispenser 10 and then the row, the deflector may be an adjustable hood for pointing and placing the flow of dispensed product near a row. The hood may be adjustable manually or automatically using a one or more position sensors and an actuator.

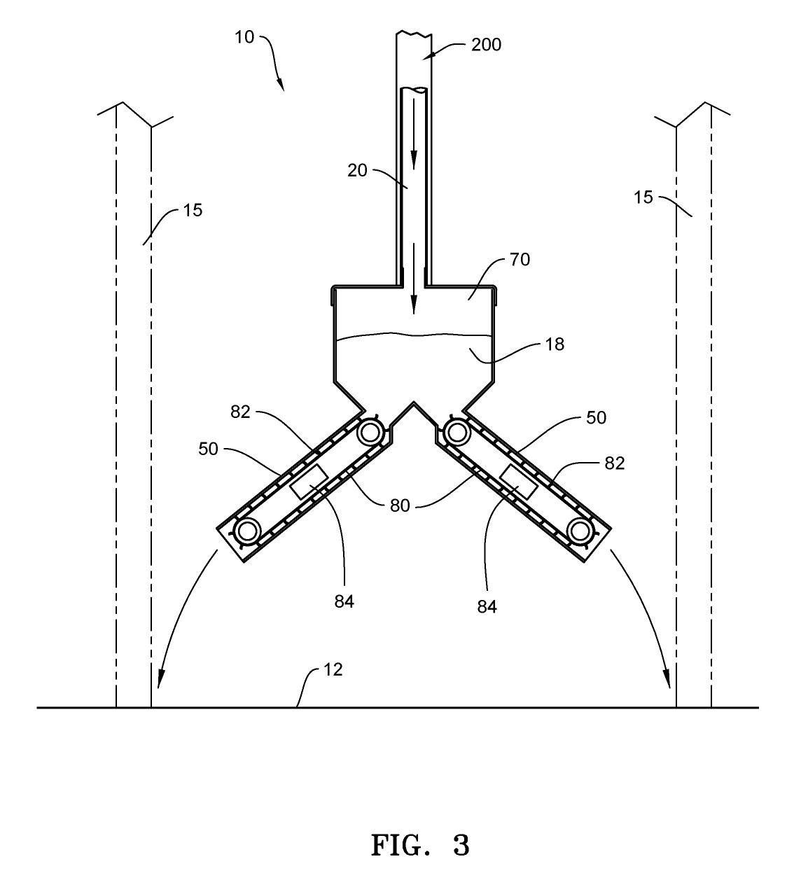

FIG. 3 shows another embodiment of a product dispenser 10. In this embodiment, the product dispenser 10 utilizes a mini-hopper 70 to receive product and supply the product to one or more rows. The mini-hopper 70 receives entrained product from a bulk hopper and associated bulk hopper meter on, for example, a self-propelled sprayer. The mini-hopper 70 allows for high pressure and/or high velocity air to be dissipated before the product is placed at the row. Product entrained in a high pressure and/or high velocity stream without compensating structures (such as a deflector) or additional controls may compromise product placement accuracy by dispersing the product over a wide area and not next to the row.

In the embodiment of FIG. 3, the dispenser 10 includes at least one endless belt 80 in each passageway 50 to move product from the mini-hopper 70 to the row through the passageways 50. The endless belt 80 may be configured to have projections or flights 82 spaced along the belt 80. The projections 82 scoop the material from the mini-hopper 70 and move it towards the discharge end of the passageway 50. The projections may form individual cells on the belt 80, each cell carrying a known volume of material. By knowing the volume of material within a cell and the speed at which the belt 80 is driven, a flow rate can be determined. Alternatively, or at least in conjunction, endless belt 80 may have one or more load cells 84 disposed underneath the belt 80 to weigh product being moved on the belt 80 and, consequently, use the weight to calculate a flow rate.

It should be appreciated that other material conveying devices may be used in place of the conveyor 80. For example, the conveying device may be a flexible auger or flexible screw conveyor 90 such as the Flex-Auger™ available from Roxell USA, 729 Industrial Park Road, Anderson Mo. 64831 or Trantec Spiral Augers available from Trantec, Renown Works, Wellington Street, Clayton-Le-Moores, Accrington UK BB5 5HU. The flexible auger may be disposed within the passageways 50 and may be of varying sizes depending upon the application needs, including the size of the product being metered. With the flexible auger 90, the passageways 50 can move material towards the row for accurate placement on the ground 12 near the base of the plants in the crop row 15. The use of a flexible auger 90 may also allow some flex or movement of the passageways when an obstacle such as rock or fence post is contacted. The flexible auger 90 efficiently moves product from the mini-hopper 70 to the row while avoiding the issues associated with high pressures and/or high velocity air and placement of the entrained product near the row discussed above. The passageway 50 may further be equipped with a flow sensor to sense the amount of material moved by the auger. In this manner, the speed of the auger 90 could be increased or decreased depending upon the desired application rate.

As shown in FIG. 1, the product dispenser 10 may also be adapted to dispense a liquid, gas or combination thereof such as foam with the particulate product. One disadvantage of the broadcast or surface application of particulate product is the uncertainty of when the product will be incorporated into the ground for consumption by a plant. When a farmer applies a dry fertilizer, the fertilizer must come into contact with soil soon, usually by being carried into the soil with rain or plant condensation, or it will volatilize and be lost to the atmosphere. If for example, urea was broadcast on top of the soil in-season and dry weather followed, it will lose a percentage of urea-based nitrogen for each day it sits on top of the soil unincorporated. However, by applying a liquid or foam on the product at the same time the product is dispensed, the product has a better chance of being incorporated into the ground and used by the plant. Modern self-propelled sprayers are often equipped with multiple tanks or compartments and means for agitating a liquid to create foam. It is envisioned then that in one example, a self-propelled sprayer is fitted with a central bulk hopper and meter and also with a tank containing a liquid, which may be water or a mixture of water and another additive, such as a urease inhibitor.

As shown in FIG. 1, a liquid dispenser 100 is provided alongside the particulate product dispenser 10 to spray or dribble a liquid, gas, or foam, onto the particulate product after being dispensed. In one example, the liquid dispenser 100 includes a liquid supply line 105 and a nozzle 110 for spraying water. In another example, the liquid is water and the water is dribbled from an open end of the supply line 105. In still yet another example, the liquid is foam and the foam is dribbled from an open end of supply line 105 onto the product on the ground 12 near the plants in the crop row 15. While the foregoing examples discuss providing a liquid or foam onto the product from the product dispenser 10, it is envisioned that any liquid or gas suitable to incorporate the dry fertilizer into the ground 12 may be provided with the liquid dispenser.

Additionally, or alternatively, as shown in FIG. 5. the drop member 200 may also support a spray assembly 300 as disclosed in U.S. patent application Ser. No. 14/245,339 and International Publication No. WO2015/154027, both of which are incorporated herein by reference in their entirety, to provide for undercanopy spray of the plants and/or soil of the crop rows. The spray assembly 300 may be adjustably positioned at a distance above the base unit 230. Thus, as shown in FIG. 5, in this embodiment, the drop member supports a particulate product dispenser 10, a liquid product dispenser 100, and a spray assembly 300. The spray assembly 300 is in communication with a liquid spray product source (not shown) via liquid spray lines 310. By adjusting the direction of spray and/or the type of nozzles used, the spray assembly 300 could spray or dribble liquid onto the plants in the adjacent crop rows or near the base of the plant rows.

The details and features of the disclosed embodiments are not intended to be limiting, as many variations and modifications will be readily apparent to those of skill in the art.

1. In a field with crops growing in adjacently spaced crop rows, a dispensing apparatus for dispensing particulate product onto a soil surface of the field adjacent the adjacently spaced crop rows, the dispensing apparatus comprising:
a plurality of drop assemblies supported by and spaced laterally along a boom structure, the boom structure disposed at a height above a soil surface and extending laterally in a direction transverse to a direction of travel and transverse to the adjacently spaced crop rows, whereby each of the plurality of drop assemblies is positioned between two of the adjacently spaced crop rows, each of the plurality of drop assemblies comprising:
a drop member extending downwardly from the boom structure toward the soil surface between the two adjacently spaced crop rows;
a hopper supported by the drop member for receiving a quantity of particulate product from a particulate product source;
particulate product passageways supported from a lower portion of the drop member, the particulate product passageways diverging laterally outward with respect to one another and the drop member;
whereby, the particulate product is communicated from the hopper to the particulate product passageways and wherein the particulate product is discharged from the particulate product passageways onto the soil surface adjacent the two adjacently spaced crop rows.

2. The dispensing apparatus of claim 1, wherein a width at a widest point of the particulate product passageways is between a range of about 9 inches to about 32 inches.

3. The dispensing apparatus of claim 1, wherein the passageways comprise a flexible hose coupled to the hopper.

4. The dispensing apparatus of claim 1, wherein the particulate product from the particulate product source is communicated to the particulate product passageways via a supply hose.

5. The dispensing apparatus of claim 1, further comprising a conveyor in communication with the hopper to move the particulate product from the hopper through the particulate product passageways and towards the adjacently spaced crop rows.

6. The dispensing apparatus of claim 1, wherein an auger is in communication with the hopper to move the particulate product from the hopper through the particulate product passageways and towards the adjacently spaced crop rows.

7. The dispensing apparatus of claim 1 wherein the lower portion of the drop member further supports liquid product passageways, the liquid product passageways having ends diverging laterally outward with respect to one another and the drop member, the liquid product passageways in communication with a liquid product source, whereby the liquid product is discharged from the liquid product passageways onto the soil surface adjacent the two adjacently spaced crop rows.

8. The dispensing apparatus of claim 7, wherein a width at a widest point of the liquid product passageways is between a range of about 9 inches to about 32 inches.

9. The dispensing apparatus of claim 1 wherein the drop member further supports at least one spray assembly in communication with a liquid spray source, the spray assembly configured to spray liquid from the liquid spray above the soil surface and onto plants in the two adjacently spaced crop rows.

10. The dispensing apparatus of claim 7 wherein the drop member further supports at least one spray assembly in communication with a liquid spray source, the spray assembly configured to spray liquid spray from the liquid spray source above the soil surface and onto plants in the two adjacently spaced crop rows.

11. A method of applying particulate product to a soil surface proximate adjacently spaced crop rows growing in a field, the method comprising:
supporting and spacing a plurality of drop members along a boom structure disposed above a soil surface and oriented transverse to a direction of travel, such that each drop member is positioned between two of the adjacently spaced crop rows growing in the field, a lower end of each of the plurality of drop members having particulate product passageways which diverge in a direction laterally outward with respect to one another and the drop member;
communicating particulate product from a particulate product supply to a hopper on each of the drop members, the hopper configured to hold a quantity of particulate product;
communicating the particulate product from the hopper to the particulate product passageways, the particulate product passageways delivering the particulate product onto the soil proximate the adjacently spaced crop rows between which each of the drop members is positioned.

12. The method of claim 11, wherein a width at a widest point of the particulate product passageways is between a range of about 9 inches to about 32 inches.

13. The method of claim 11, wherein the passageways are coupled to a flexible hose at an end of each of the particulate product passageways.

14. The method of claim 11, wherein the particulate product from the particulate product supply is communicated to the particulate product passageways via a supply hose.

15. The method of claim 11, wherein a conveyor in communication with the hopper moves the particulate product from the hopper to the particulate product passageways and towards the adjacently spaced crop rows.

16. The method of claim 11 wherein the lower end of the drop member further supports liquid product passageways, the liquid product passageways having ends diverging laterally outward with respect to one another and the drop member, the liquid product passageways in communication with a liquid product source, whereby the liquid product is discharged from the liquid product passageways onto the soil surface adjacent the adjacently spaced crop rows.

17. The dispensing apparatus of claim 16, wherein a width at a widest point of the liquid product passageways is between a range of about 9 inches to about 32 inches.

18. The method of claim 11 wherein the drop member further supports at least one spray assembly in communication with a liquid spray source, the spray assembly configured to spray liquid from the liquid spray above the soil surface and onto plants in the adjacently spaced crop rows.

19. The method of claim 16 wherein the drop member further supports at least one spray assembly in communication with a liquid spray source, the spray assembly configured to spray liquid spray from the liquid spray source above the soil surface and onto plants in the adjacently spaced crop rows.
